(19) United States
(12) Patent Application Publication
(10) Pub. No.: US 2010/0176681 A1
(43) Pub. Date: Jul. 15, 2010

(54) TOOTHED ROTOR EQUIPPED WITH FERROMAGNETIC INTERPOLAR ELEMENTS OF OPTIMIZED WIDTH AND ROTARY MACHINE EQUIPPED WITH SUCH A ROTOR

(76) Inventors: Olivier Gas, Paris (FR); Marc Tunzini, Versailles (FR); Stéphane Rigaud, Saint Maurice (FR)

Correspondence Address: BERENATO & WHITE, LLC, 6550 ROCK SPRING DRIVE, SUITE 240, BETHESDA, MD, 20817, US

(21) Appl. No.: 12/441,080

(22) PCT Filed: Aug. 20, 2007
(86) PCT No.: PCT/FR07/51831

§ 371 Date: Dec. 8, 2009

(30) Foreign Application Priority Data
Oct. 10, 2006 (FR) 0654172

(51) Int. Cl. H02K 21/04; H02K 1/27

(52) U.S. Cl. 310/156.45; 310/181

(57) ABSTRACT

A rotating electrical machine rotor which comprises: a rotary shaft; two field spiders which have the same diameter ranging between 90 and 120 mm and which are mounted centred on the shaft, each field spider comprising a circular radial plate; prongs extending axially toward the other field spider so as to nest tangentially between two adjacent axial peripheral prongs of the other field spider; an interpolar tangential space left between the opposing parallel lateral faces of two consecutive prongs of each field spider; and at least one ferromagnetic interpolar element the width (Lf) of which is defined orthogonal to the lateral faces of the adjacent prongs. According to the invention, the active width (Lf) of the ferromagnetic element is between 5 mm and 6 mm.

The invention concerns a rotating electrical machine rotor comprising two field spiders with prongs.

The invention relates more specifically to a rotating electrical machine rotor, in particular for a motor vehicle, which comprises:

a rotary shaft mounted about an axial axis of rotation;

a front field spider and a rear field spider which have the same external diameter of between 90 and 120 mm, and which are mounted centred on the shaft, each field spider comprising a circular radial plate;

prongs extending axially in the direction of the other field spider from a base arranged at the periphery of the plate of each field spider as far as a free end, each prong of a field spider being nested tangentially between two adjacent axial peripheral prongs of the other field spider, each prong being delimited tangentially by two lateral faces;

an interpolar tangential space left between the opposing parallel lateral faces of two consecutive prongs of each field spider;

at least one ferromagnetic element which is arranged in at least one interpolar space and has a width which is defined orthogonally to the lateral faces of the adjacent prongs.

The invention also concerns a rotary electrical machine comprising:

a rotor made according to the teaching of the invention;

a stator comprising an annular body coaxial to the rotor comprising axial grooves distributed at regular intervals along the annular body with a predetermined tooth pitch, and which comprises a polyphase stator winding comprising a plurality of phase windings which are arranged in associated series of grooves.

Rotating electrical machine rotors of this type are already known in the art. When a rotating electrical machine equipped with such a rotor is in use, the prongs of each field spider form magnetic poles, for example north for the first field spider, and south for the second field spider. The magnetic flux which circulates from the poles of one field spider to the poles of the other field spider passes through the coils formed by a stator winding surrounding the rotor.

Such a rotating electrical machine is, for example, an alternator which is used to produce electric current in the stator winding when the rotor is mechanically driven in rotation.

To prevent the magnetic flux emitted by these poles from short-circuiting the coils of the stator winding, it is known in the art to interpose permanent magnets formed by ferromagnetic elements between two consecutive opposite poles of the rotor.

The present invention is intended in particular to improve the output of such a rotating electrical machine by proposing a rotor of the type described previously in which the active width of the ferromagnetic element is between 5 mm and 6 mm.

According to other characteristics of the invention:

the ferromagnetic element comprises at least two pieces of ferromagnetic material which are stacked tangentially in the interpolar space, the active width of the ferromagnetic element being equal to the sum of the active widths of the pieces of ferromagnetic material;

each prong has a trapezoidal shape, which converges from the base towards the free end, the lateral faces of each prong forming a prong angle in relation to the axial direction, and in that the width of the interpolar space is adapted to the width of the ferromagnetic element by reducing the prong angle;

each field spider comprises six prongs;

each field spider comprises eight prongs.

The present invention also proposes a rotating electrical machine equipped with such a rotor, presenting reduced magnetic noise. To this end, the rotating electrical machine is characterised in that the tooth pitch is less than the length of the lateral face of each prong in axial projection so as to minimise the magnetic noise.

According to other characteristics of the rotating electrical machine:

the stator winding comprises at least six phase windings;

the stator comprises thirty-six grooves;

the stator comprises seventy-two grooves;

the stator comprises forty-eight grooves.

Other advantages and characteristics will become apparent in the course of reading the detailed description which will follow, for the understanding of which reference should be made to the attached drawings, among which:

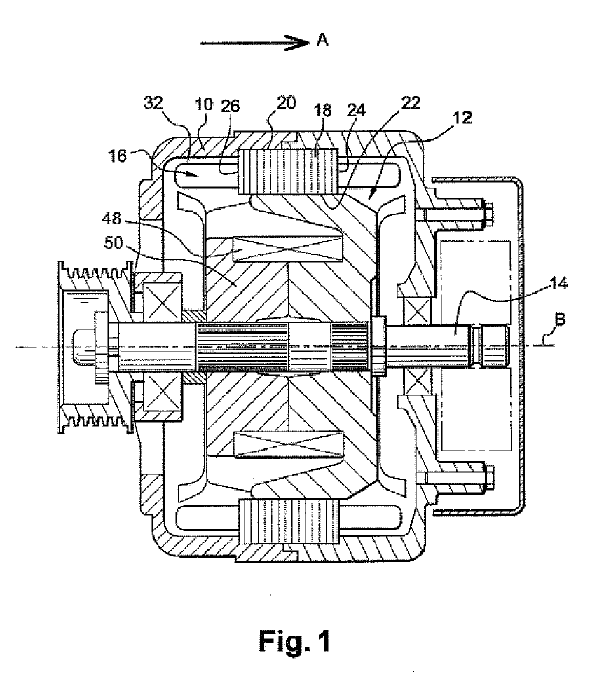

FIG. 1 is a view in axial section of an alternator equipped with a rotor;

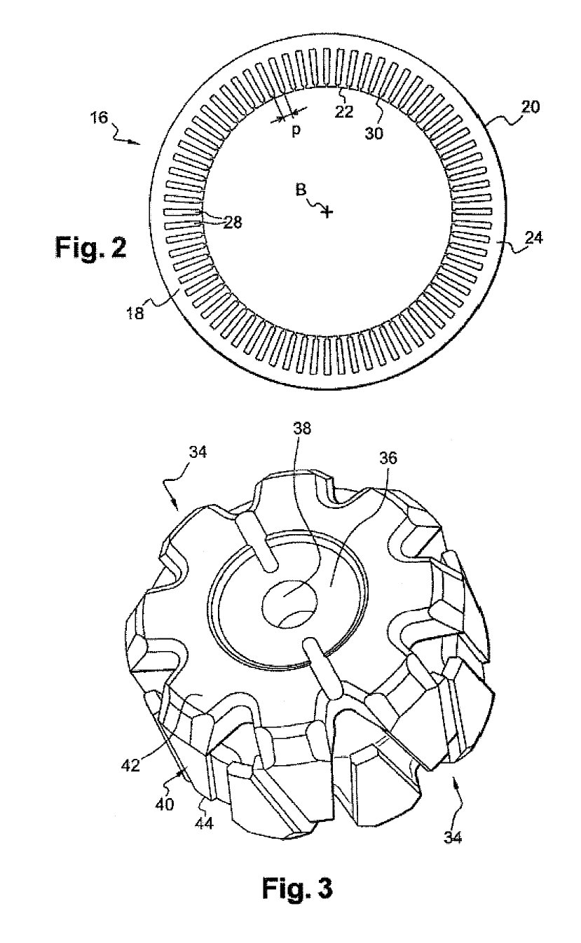

FIG. 2 is an axial view showing the stator body of the alternator from FIG. 1;

FIG. 3 is a diagram in perspective of the field spiders of the rotor shown in FIG. 1, which comprises ferromagnetic elements mounted between the axial prongs in accordance with the invention;

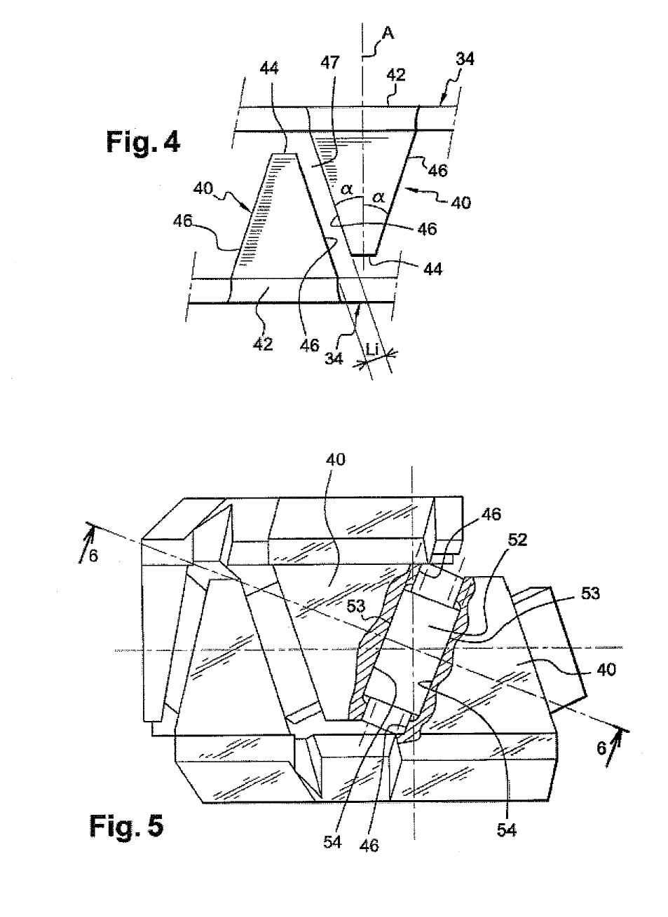

FIG. 4 is a partial top view showing two prongs belonging respectively to the first field spider and to the second field spider;

FIG. 5 is a view similar to that from FIG. 4 with partial tearaway, showing the field spiders equipped with a ferromagnetic element which is arranged in the interpolar space;

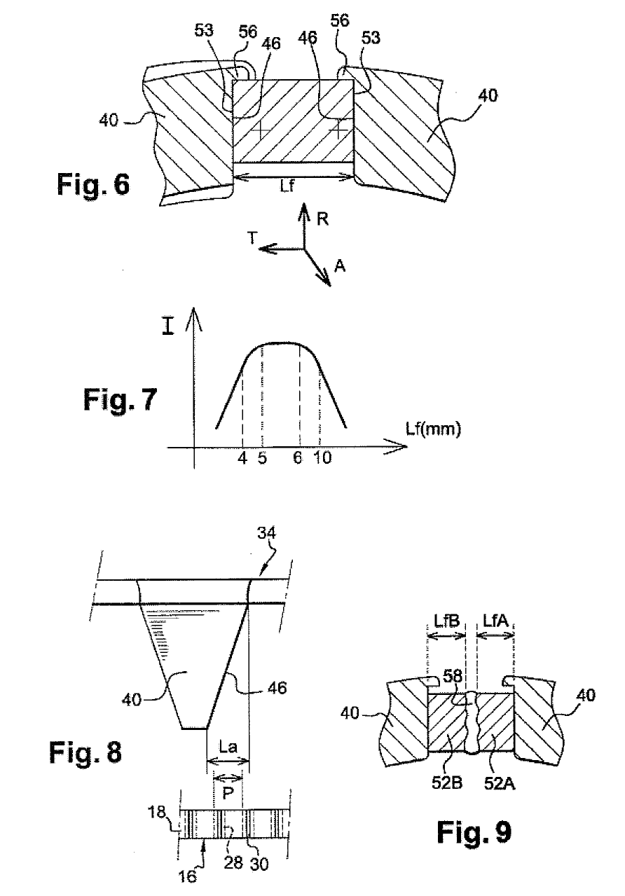

FIG. 6 is a view in section according to the line 6-6 of the teeth shown in FIG. 5;

FIG. 7 is a curve which represents the efficacy of the intensity of the electric current induced in the stator when the rotor rotates at 1800 r.p.m. depending on the active width of the ferromagnetic element;

FIG. 8 is a partial expanded view showing one prong of a field spider which is arranged to the right of the grooves of the stator;

FIG. 9 is a view similar to that in FIG. 6 which represents a variant of the invention.

In the rest of the description, analogous, similar or identical elements will be designated by the same reference numbers.

The rest of the description adopts an axial orientation indicated by the arrow “A” in FIGS. 1 and 6 which points from back to front, a radial orientation which extends perpendicularly to the axial axis of orientation of the rotor and which is indicated by the arrow “R” from FIG. 6 which points from bottom to top, and a tangential orientation which is orthogonal to the axial “A” and radial “R” orientations and which is indicated by the arrow “T” from FIG. 6.

Furthermore, the radial faces oriented towards the middle of the rotor will be referred to as internal faces, while the faces oriented in the opposite direction will be referred to as external faces. Equally, the axial faces oriented towards the axis of rotation of the shaft will be referred to as internal faces while the axial faces oriented in the opposite direction will be referred to as external faces.

In reference to FIG. 1, a rotating electrical machine is shown, in the present case an alternator of the polyphase type for a motor vehicle with a heat engine. Obviously, the alternator may also be reversible and consist of an alternator-starter, in particular to start the heat engine of the vehicle.

When the machine runs in alternator mode, it transforms mechanical energy into electrical energy like any other alternator.

When the machine runs in electric motor mode, especially in starter mode to start the heat engine of the vehicle, it transforms electrical energy into mechanical energy.

This machine essentially comprises a casing 10 and, inside this casing, a rotor 12 which comprises a central shaft 14. The central shaft 14 is mounted so as to rotate in relation to the casing 10 about its axial axis of orientation “B”. The casing 10 also encloses a stator 16 which surrounds the rotor 12.

As shown in FIG. 2, the stator 16 comprises an annular cylindrical body 18 coaxial with the rotor 12. The stator is formed by a pack of axially stacked metal laminations. The annular body 18 is radially delimited by an external cylindrical face 20 and by an internal cylindrical face 22, and it is axially delimited by a front radial annular face 24 and by a rear radial annular face 26.

The annular body 18 comprises a plurality of grooves 28 which extend axially so as to open out in each of the front 24 and rear 26 radial faces. The annular body 18 here is of the semi-closed type, i.e. each groove 28 also opens out radially in the internal cylindrical face 22 through an axial slot 30 to enable the mounting of a stator winding 32 forming coil ends on either side of the annular body 16.

The grooves 28 are distributed at regular intervals all around the annular body 18 with a predetermined tangential tooth pitch “p” between two adjacent grooves 28. The tooth pitch “p” is more specifically defined here by the distance at the level of the internal cylindrical face 22 between the radial axial median plane of a first groove 28 and the radial axial median plane of a second adjacent groove 28.

This stator winding 32 is, for example, a hexaphase winding, which then comprises a set of six phase windings. The outputs of the stator winding 32 are connected to a bridge rectifier (not shown) comprising rectifier elements such as diodes or transistors of the MOSFET type, in particular when the machine is of the reversible type and consists of an alternator-starter as described, for example, in the document FR-A-2,725,445 (U.S. Pat. No. 6,002,219).

Each phase winding is obtained by using a continuous, electrically-conductive wire, covered in an insulating layer and mounted in associated series of grooves 28 of the annular body 18 of the stator 16. In the embodiment shown in the figures, the stator winding 32 comprising six phase windings, the conducting wire of a phase winding is inserted every six grooves 28.

According to one variant, to reduce the ripple factor and magnetic noise, the stator winding 32 comprises two sets of triphase windings to form a composite stator winding device, the windings being offset by thirty electrical degrees, as described, for example, in the documents US-A1-2002/0175589, EP-0,454,039 and FR-A-2,784,248. In this case, two bridge rectifiers are provided and all combinations of three-phase windings in star and/or delta are possible.

It should be noted that in the embodiment described, as will be seen later, the rotor 12 comprises eight pairs of poles. So forty-eight grooves 28 are provided in the body of the stator 16 if two sets of three-phase windings are provided, as described in the previously cited document FR-A-2,737,063, or ninety-six grooves 28 in the solutions described in the previously cited documents US-A1 2002/0175589 and EP-A1 0,454,039.

Obviously the rotor 12 may, depending on the applications, comprise a different number of pairs of poles.

According to one variant, not shown, for a better filling of the grooves 28 of the body 18 of the stator 16, the windings are realised by using bar-shaped conductors, such as pins, connected together, for example, by welding.

Generally, the alternator is of the polyphase type, preferably comprising more than three phase windings, as will be explained further on in the description. The rectifier bridge or bridges make it possible, in particular, to rectify the alternating current produced in the windings of the stator 16 into a direct current, in particular to charge the battery (not shown) of the motor vehicle and to supply the loads and electrical consumer units in the onboard system of the motor vehicle.

The rotor 12 is a pronged rotor, as described for example in the documents US-A1-2002/0175589 and EP-A1-0,454,039, comprising a first front field spider 34 and a second rear field spider 34 which are axially juxtaposed. Each field spider 34 comprises a globally circular radial plate 36 provided with a central orifice 38 through which passes the rotation shaft 14. Each field spider 34 is connected in rotation with the rotation shaft 14.

As shown in FIG. 3, each field spider 34 also comprises prongs 40 which extend axially from a base 42 arranged at the external periphery of the plate 36 to a free end 44 towards the interior in the direction of the other field spider 34. Each field spider 34 here comprises eight prongs 40.

According to one variant, not shown, each field spider 34 comprises six prongs 40.

The prongs 40 are distributed at regular intervals over the circumference of the plate 36 of the field spider 34. All the prongs 40 are identical here.

As illustrated in FIG. 4, each prong 40 has a trapezoidal shape converging from the base 42 to the free end 44. Each prong 40 is tangentially delimited by two radial lateral faces 46. More particularly, each prong 40 here forms a truncated isosceles triangle, the apex of which forms the free end 44 of the prong 40 and the base of which is formed by the base 42 of the prong 40. Each lateral face thus forms the same angle “α” in relation to the axial direction “A”. Henceforth, this angle “α” will be referred to as the “prong angle”.

Each prong 40 of a field spider 34 is nested between two consecutive prongs 40 of the other field spider 34 such that each lateral face 46 of the prongs 40 of the first field spider 34 is arranged facing a lateral face 46 of a prong 40 of the second field spider 34 and vice versa. The prongs 40 of the two field spiders being identical, the opposing lateral faces 46 are substantially parallel.

The prongs 40 of the first front field spider 34 are intended to form magnetic poles of a first sign, for example north, while the prongs 40 of the second rear field spider 34 are intended to form magnetic poles of a second sign, for example south. So the nested prongs 40 form an alternating sequence of north pole and south pole.

The field spiders 34 are not in contact with each other. To this end, an interpolar tangential space 47 is reserved between the prongs 40 of the first front field spider 34 and of the second rear field spider 34. So, two associated opposing lateral faces 46 are spaced apart from each other by a width “Li” and they delimit the interpolar space 47.

In the rest of the description and in the claims, the “width” will be determined according to an axis orthogonal to the opposing lateral faces 46 which delimit the interpolar space 47 in question.

In reference to FIG. 1, a field coil 48 is implanted axially between the plates 36 of the field spiders 34. It is supported by a portion of the rotor 12 in the form of a cylindrical annular core 50 coaxial to the shaft 14, which comprises a central bore. In a non-limitative fashion, the core 50 here consists of two axially distinct sections, each of which is produced from the same material as an associated field spider 34.

In the manner known in the art, ferromagnetic elements 52, such as permanent magnets, are arranged in at least one interpolar space 47 of the rotor 12. In the example shown in the figures, the rotor 12 comprises sixteen ferromagnetic elements 52, each of which is arranged in an associated interpolar space 47 of the rotor 12, i.e. all of the interpolar spaces are equipped with ferromagnetic elements 52.

According to one variant of the invention, not shown, only some of the interpolar spaces are equipped with ferromagnetic elements 52.

As shown in FIGS. 5 and 6, each ferromagnetic element 52 here is formed by a single parallelepiped bar, with an axis parallel to the associated lateral faces 46 of the interpolar space 47, which is constituted entirely of a ferromagnetic material. All the ferromagnetic elements here are identical in form and dimensions.

The ferromagnetic element 52 is more particularly delimited tangentially by two north and south polar radial faces 53, which are arranged facing each of the lateral faces 46 of the interpolar space 47. More precisely, the north polar face 53 is arranged opposite the lateral face 46 of the prong 40 of the north field spider 34 and the south polar face 53 is arranged opposite the lateral face 46 of the prong 40 of the south field spider.

In the manner known in the art, the ferromagnetic elements 52 are arranged in substantially axial grooves 54 which are formed in the lateral faces 46 which delimit the interpolar space 47.

The external edge of each lateral face 46 comprises more particularly a rim 56 which extends tangentially towards the interior of the interpolar space 47 so as to retain the ferromagnetic element 52 radially against the centrifugal force when the rotor 12 is in rapid rotation.

When the alternator is in use, the field coil 48 of the rotor 12 is supplied with electricity in such a way that a magnetic field with an axial axis “B” is induced. This magnetic rotor field is channelled by the field spiders 34 so as to re-emerge via the prongs 40.

The ferromagnetic elements 52 arranged in the interpolar spaces are oriented so as to prevent the magnetic flux from “jumping” directly from one field spider 34 to the other by passing through the interpolar space 47. Thus, the magnetic flux is deformed in such a way that it is redirected to the coils of the winding 32 of the stator 16.

The rotor 12 is then driven in rotation about its “B” axis and, in accordance with a well-known physical phenomenon, the passage of each prong 40 radially to the right of each coil of the phase windings of the winding 32 of the stator 16 induces an electric current in the winding 32 of the stator 16.

According to the teachings of the invention, the active width “Lf” of each ferromagnetic element 52 is selected from a range of values of between 4 mm and 10 mm for a rotor 12 with an external diameter of between 90 mm and 120 mm. It has in fact been found that, surprisingly, by arranging ferromagnetic elements 52 with an active width of between this range of active widths “Lf” in some or all of the interpolar spaces 47, the intensity of the electric current induced in the winding 32 of the stator 16 is optimal.

Thus, as shown in FIG. 7, it has been found by measurement that when the rotor 12 rotates at a speed of 1800 r.p.m., the intensity of the electric current induced in the winding 32 of the stator 16 presents a peak when the active width “Lf” of the ferromagnetic elements 52 falls within the range of values between 4 mm and 10 mm.

Advantageously, the optimum output is attained when the active width “Lf” of the ferromagnetic element 52 is selected from the range of between 5 mm and 6 mm.

According to another aspect of the invention, the width “Li” of the interpolar space 47 is adapted to the active width “Lf” of the ferromagnetic element 52, i.e. the width “Li” of the interpolar space 47 must be substantially equal to the width “Lf” of the ferromagnetic element 52.

In practice, the width “Li” of the interpolar space 47 is always slightly greater than that of the ferromagnetic element 52 in order that the ferromagnetic element 52 does not suffer any compression stresses between the two prongs 40, but the polar faces 53 must be very close together, and ideally in contact with the lateral faces 46 for maximum efficacy.

To this end, the width “Li” of the interpolar space 47 of the rotor 12 must be suitable in relation to rotors which are already known.

It is impossible to increase the tangential length of the base 42 of the prongs 40, since this dimension is imposed by design constraints. The width “Li” of the interpolar space 47 is thus adapted by reducing the prong angle “α” formed between the lateral faces 46 and the axial direction “A”. The prong angle “α” is generally between 10° and 25°.

However, this adaptation tends to affect the noise produced by the alternator when it is in use.

In fact, when it is in use, the powerful magnetic field which circulates between the rotor 12 and the stator 16 produces a cyclical radial load on the prongs 40. The prongs 40 thus flex elastically towards the exterior at each passage to the right of a groove 28 of the stator 16 which corresponds to the end of one coil and to the start of the next coil. Thus, when the rotor 12 turns at very high speed, for example, in the region of 1800 r.p.m., the prongs 40 vibrate, producing an unpleasant whistling commonly known as “magnetic noise”.

To prevent this magnetic noise from becoming too intense, the tangential length “La” in axial projection of each lateral face 46 is greater than the tooth pitch “p” of the grooves 28 of the stator 16 so that the lateral faces 46 of the prongs 40 are not subjected abruptly and simultaneously over their entire length to the change of coil, as shown in FIG. 7. The tangential length in axial projection “La” of each lateral face 46 is obtained by multiplying the length of the lateral face by the sine of the prong angle “α”.

In general it is preferable, to reduce the magnetic noise, for the prong angle “α” to satisfy the following in equation:

$$α \geq Arctan ( \frac{{φ}_{stator} \times π}{N \times PP \times ϕ \times Hp} )$$

where:
φₛₜₐₜₒᵣ is the internal diameter of the stator 16, which is substantially equal to the external diameter of the field spiders 34;

N is the number of grooves 28 per pole and per phase;

φ is the number of phase windings;

Hp is the axial length of a prong 40.

The invention thus proposes that the stator 16 is equipped with a large number of grooves 28, for example thirty-six, forty-eight or more, so that the tooth pitch “p” is reduced in order to be adapted to the new prong angle “α”, i.e. the tooth pitch “p” is less than the length in axial projection “La” of the lateral faces 46.

In general the number of grooves 28 is a multiple of the product of the number of phases of the stator winding 32 by the number of prongs 40 of a field spider 34.

Advantageously, such a stator 16 is suitable to receive a stator winding 32 comprising more than three phases, for example a hexaphase or double three-phase winding. However, the invention is not limited to such a number of phases, and any other number of phases which enables a tooth pitch “p” to be achieved which is less than the length in axial projection “La” of each lateral face 46 also enters into the field of application of the present invention.

According to a second embodiment shown in FIG. 9, the ferromagnetic element 52 is formed from at least two disjointed parts 52A, 52B each made from ferromagnetic material, which are stacked tangentially in the interpolar space 47. Such an embodiment is described, for example, in the document FR-A-2,784,248, on pages 6 and 7.

The two parts 52A, 52B here are parallelepipeds with an axis parallel to the lateral faces 46. These two parts 52A, 52B are here fixed to each other with the interposition of a flexible, radial layer of adhesive. Each part 52A, 52B has an active width referred to as “LfA” and “LfB” respectively.

According to the teaching of the invention, the active width of the ferromagnetic element 52 is equal to the sums of the active widths “LfA+LfB” of these two ferromagnetic parts 52A, 52B, excluding the width of the layer of adhesive, and falls into the previously defined optimal range.

In general, it will be understood that the active width “Lf” of the ferromagnetic element 52 is equal to the sums of the widths “LfA +LfB” of all the ferromagnetic parts 52A, 528 which are stacked tangentially between the two lateral faces 46 of an interpolar space 47, without taking into consideration any interposed layers of non-magnetic material.

1. Rotating electrical machine rotor (12), in particular for a motor vehicle, which comprises:
a shaft (14) mounted so as to rotate about an axial axis of rotation (B);
a front field spider (34) and a rear field spider (34) which have the same external diameter of between 90 and 120 mm, and which are mounted centred on the shaft (14), each field spider (34) comprising a circular radial plate (36);
prongs (40) extending axially toward the other field spider (34) from a base (42) arranged at the periphery of the plate (36) of each field spider (34) as far as a free end (42), each prong (40) of a field spider (34) being nested tangentially between two adjacent axial peripheral prongs (40) of the other field spider (34), each prong (40) being delimited tangentially by two lateral faces (46);
an interpolar tangential space (47) left between the opposing parallel lateral faces (46) of two consecutive prongs (40) of each field spider (34);
at least one ferromagnetic element (52, 52A, 52B) which is arranged in at least one interpolar space (47) and having a width (Lf) defined orthogonally to the lateral faces (46) of the adjacent prongs (40);
wherein the active width (Lf) of the ferromagnetic element is between 5 mm and 6 mm.

2. Rotor (12) according to claim 1, wherein the ferromagnetic element (52) comprises at least two pieces (52A, 52B) of ferromagnetic material which are stacked tangentially in the interpolar space (47), the active width (Lf) of the ferromagnetic element (52) being equal to the sum of the active widths (LfA+LfB) of the pieces of ferromagnetic material (52A, 52B).

3. Rotor (12) according to claim 2, wherein each prong (40) has a trapezoidal shape which converges from the base (42) towards the free end (44), the lateral faces (46) of each prong (40) forming a prong angle (α) in relation to the axial direction (A), and in that the width (Li) of the interpolar space (47) is adapted to the active width (Lf) of the ferromagnetic element (52) by reducing the prong angle (α).

4. Rotor (12) according to claim 1, wherein each field spider (34) comprise six prongs (40).

5. Rotor (12) according to claim 1, wherein each field spider (12) comprises eight prongs (40).

6. Rotating electrical machine comprising:
a rotor (12) made according to claim 3;
a stator (16) which comprises an annular body (18) coaxial to the rotor (12) comprising axial grooves (28) distributed at regular intervals along the annular body (18) with a predetermined tooth pitch (p), and which comprises a polyphase stator winding (32) comprising a plurality of phase windings which are arranged in associated series of grooves (28);
wherein the tooth pitch (p) is less than the length (La) of the lateral face (46) of each prong (40) in axial projection so as to minimize magnetic noise.

7. Rotating electrical machine according to claim 6, wherein the stator winding (32) comprises at least six phase windings.

8. Rotating electrical machine according to claim 6, wherein the stator (16) comprises thirty-six grooves (28).

9. Rotating electrical machine according to claim 6, wherein the stator (16) comprises seventy-two grooves (28).

10. Rotating electrical machine according to claim 6, wherein the stator (16) comprises forty-eight grooves (28).
